(19) United States
(12) Patent Application Publication
(10) Pub. No.: US 2007/0279624 A1
(43) Pub. Date: Dec. 6, 2007

(54) Sensitive System for Detecting Chemical and/or Physical State Changes Inside Packaged Media

(75) Inventor: Matthias Lau, Dresden (DE)

Correspondence Address: YOUNG & BASILE, P.C., 3001 WEST BIG BEAVER ROAD, SUITE 624, TROY, MI, 48084, US

(73) Assignee: Sentronic GMBH Gesellschaft Fur Optische Messssysteme, Dresden (DE)

(21) Appl. No.: 10/582,021

(22) PCT Filed: Dec. 12, 2004
(86) PCT No.: PCT/DE04/02732

§ 371 Date: Apr. 2, 2007

(30) Foreign Application Priority Data
Dec. 8, 2003 (DE) 103 57 598.7

(51) Int. Cl. G01N 21/01

(52) U.S. Cl. 356/256

(57) ABSTRACT

The invention relates to a sensitive system for detecting chemical and/or physical state changes, preferably inside packages, of small sample volumes or a high-viscosity medium containing substances or the mixtures thereof. The aim of said invention is to make it possible to check at a low cost the state of said substances or the mixtures thereof or of different media. For this purpose, the inventive sensitive system is designed in such a way that a membrane or a sensitive film (1) is arrangeable on or in an element (3) which is interchangeably connectable to a cannula (2), thereby making it possible to introduce the element (3) and the cannula (2) into a measurable medium and to form an optical connection with an optical sensor system (4).

This invention relates to a sensitive system for detecting chemical and/or physical state changes preferably within packages, small sample volumes or highly viscous media containing substances or mixtures of substances. It is suitable in particular for monitoring the state of foods or other perishable substances.

The invention is intended according to the problem to provide a possibility for checking the state of the particular medium in economical fashion.

The inventive sensitive system for detecting chemical and/or physical states or state changes within substances or mixtures of substances is so formed that a membrane or layer sensitive to at least one state change or state monitoring is present on an element. Said element with the layer or membrane can be fastened replaceably on/in the tip of a cannula, so that the element can be disposed of after use and the rest of the system, that is, a cannula with an optical sensor system, can be multiply used.

The inventive system can be inserted with the slipped-on element through the otherwise closed package or into solid or highly viscous media, which can be done by piercing. The membrane or layer then located within the medium, and the optical sensor system can then be used to detect the particular state of at least one measurand.

The optical sensor system is formed of at least one optical detector and a light source, so that optical changes on or also in the particular layer or membrane can be detected in dependence on the particular state in the medium.

The hollow cannula can already alone form an optical waveguide through which for example light for exciting luminescence or also surface plasmon resonance can be directed onto the layer or into a membrane. Light reflected or emitted there can be redirected by such a hollow cannula onto an optical detector and the latter used to perform an optical evaluation for detecting the particular state or a state change in the package.

It is also possible to guide an optical waveguide through a hollow cannula, whereby such an optical waveguide may be at least one optical fiber.

States or state changes can be detected by interferometry, spectroscopy or, as indicated above, via surface plasmon resonance or luminescence intensity changes.

It is thus also possible to detect a changing thickness of layers.

Besides the oxygen concentration within the package, which can frequently be a suitable indicator for the state of foods contained in packages, it is also possible to detect concentrations of hydrocarbons, hydrogen or not only physical parameters such as pressure or temperature but also the presence of water. Suitable dyes or selective markers can be present in or on a membrane or layer. Thus, it is possible to use dyes having a luminescence quenching effect under the influence of certain substances, so that the luminescence intensity accordingly detected with an optical detector can be a measure of the particular concentration of a substance.

It is also possible to use markers or dyes that are sensitive dependently on temperature or pressure and which might also involve a color change. Advantageously, the changeable element should bear a piercing protection, a so-called pencil point, which protects the sensitive membrane or layer from mechanical influences.

The membrane or layer to be used according to the invention can also have been formed directly on a fiber optic system or optic.

Membranes or layers can also have been accordingly fixed to the element with the help of an adhesive film or be immobilized directly in the element.

Calibrations can be performed when the package is being closed or inside closed calibrating vessels by adjusting specific changes of the measurand, for example by vacuums or excess pressures, by supplying a calibrating gas or with specific temperature variation.

The membranes or layers to be used according to the invention can also have applied thereto optical or chemical protective layers, for example to reduce reflections or the influence of moisture.

Aggressive media, such as acids, can also be reduced in their influence by means of a chemical protective layer.

Thus, layers permeable to the corresponding substances (fluids/gases) to be measured can advantageously be formed. These may be metal layers of corresponding thickness, preferably noble metal layers, particularly preferably silver layers.

An especially suitable chemical protective layer has proved to be PTFE layers or PTFE-based layers, metallic layers or dielectric layers.

Within limits, the elements with membrane and layer can also be disinfected or sterilized, which can be done by autoclave treatment or irradiation with gamma rays. This makes it possible to obtain multiple use within certain limits.

The inventive system permits detections without any consumption of the particular substance during detection being observed, so that measurements can also be done in extremely small volumes over long time periods without any corresponding systematic measuring errors being observed.

Short time constants and response times can be obtained, and no additional elements are required for removing the medium under measurement (fluid/gas) from a package.

Hereinafter the invention will be explained more closely by way of example.

The figures are described as follows:

FIG. 1 a sectional view of a bottom portion of an element to be used on an inventive system;

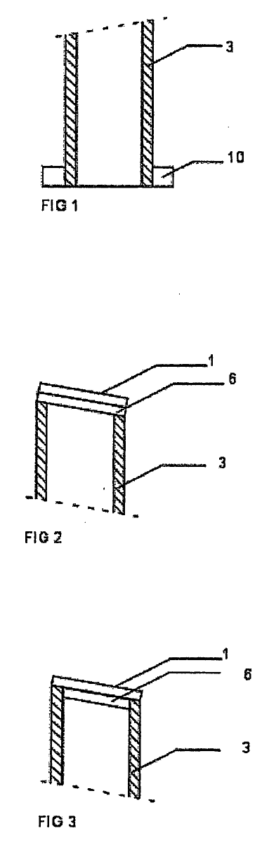

FIG. 2 an example in a sectional view of an element (upper portion) to be used on an inventive sensitive system;

FIG. 3 a further example of an element (upper portion) to be used on an inventive system;

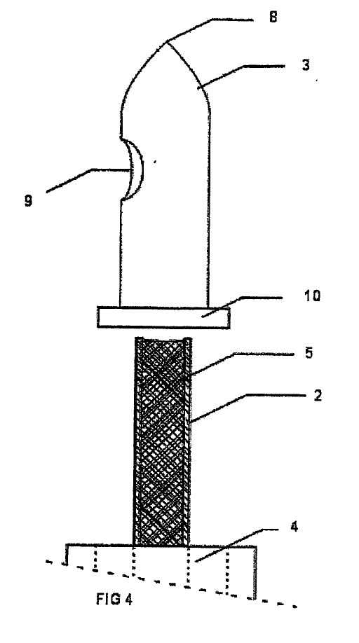

FIG. 4 a schematic representation of an inventive sensitive system;

FIG. 5 a section for an example of a piercing protection which can be used on an inventive system, and

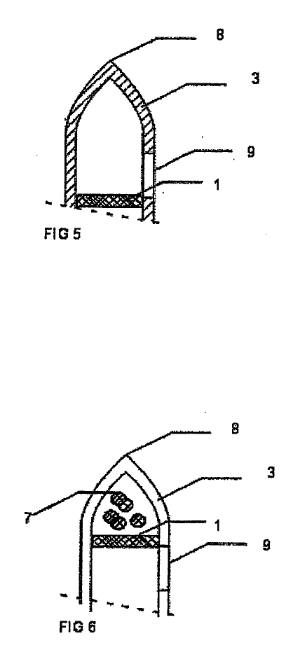

FIG. 6 a further example of a piercing protection.

FIG. 1 shows a sectional view through a bottom portion of an element 3 which can be used on an inventive system.

Here, the element 3 is formed obliquely inclined on the front face, and on the opposite face there is a connecting element 10, which should advantageously be formed as a Luer lock connection.

A cannula 2 or the element (3) can be completely hollow inside, in which case it is advantageous if the inner surface is formed to reflect electromagnetic radiation or provided with a coating suitable therefor.

In a form not shown, optical elements can also be disposed inside the cannula 2. Possible elements to be used here are different optical waveguides 5, for example optical fibers or also optical imaging elements, such as GRIN lenses.

FIGS. 2 and 3 show two examples of elements 3 connectable to a cannula. The upper portion of element 3 is shown. The connectable elements 3 can be simply slipped on a cannula 2 from above and then optionally locked.

With the elements 3 shown in FIGS. 2 and 3, an optical element 6 provided with a sensitive membrane or layer is disposed on the upper face of each such element and preferably connected to the element 3 in material-locking fashion.

Here, the optical element/part 6 may be an optically transparent carrier which is formed for example of a glass on which a sensitive membrane or layer 1 has been formed.

The sensitive membrane or layer 1 may also, in contrast to the representation in FIGS. 2 and 3, form a single element with the optical element, whereby at least the outwardly pointing area of such an element must be sensitive and can perform the function of a sensitive membrane or layer 1.

The material-locking connection can be formed in different ways, for example by bonding or soldering, or also as a fused joint.

It is in particular advantageous to provide in the example according to FIG. 2 in favorable form an element with which organic components can be completely omitted in the production of the material-locking connection. Here, on the element 3, the element 3 hollow in the inside for being slipped on a cannula 2 a glass plate as an optical element 6 can be placed on, and the glass is heated by a heat treatment to such an extent that a fused joint is formed. Subsequently a sensitive membrane or layer 1 can then be formed on the outer surface.

In the example shown in FIG. 3, the optical element 6 has been received inside tie element 3 connectable to the cannula 2.

In a form not shown, the optical element 6 can also be at least one optical waveguide, for example optical fiber, or also an optical imaging element or a system of optical imaging elements, such as a GRIN lens.

FIG. 4 shows in schematic form an example of an inventive sensitive system.

Here, a cannula 2 is connected to an optical sensor system 4, with an optical waveguide 5 being guided through the cannula 2.

The two form a one-piece structure and can be multiply used.

For at least a single detection, an element 3 with a piercing protection 8, which can also be designated a pencil point, can then be slipped on the cannula 2.

Such an element 3 with a piercing protection 8 can also have present thereon a connecting element 10, which can likewise be formed as a Luer lock connection, for connecting the element 3 with the optical sensor system 4 and for positioning a fixation of the element 3 with piercing protection 8 and a membrane or layer 1, not recognizable here, disposed inside the piercing protection 8.

The piercing protection 8 has present thereon at least one opening 9 through which is medium under measurement can enter inside for detection with the sensitive membrane or layer 1. FIG. 5 shows a possible arrangement of a sensitive membrane or layer 1 within a piercing protection 8. Here, the sensitive membrane or layer 1 is disposed below the opening 9 and a corresponding cavity present within the piercing protection 8 above the sensitive membrane or layer 1 for receiving the particular medium under measurement, substance or mixture of substances, so that the latter can come in direct contact with the sensitive membrane or layer 1.

In the example of a piercing protection 8 shown in FIG. 6, which, as also in the examples shown in FIGS. 4 and 5, can be an element 3 connectable to the other parts of the inventive system, a sensitive membrane or layer 1 is disposed above an opening through which medium under measurement, substance or mixture of substances can enter.

The space above the sensitive membrane or layer 1 is filled in this example with a filler 7 to avoid a possible dead volume.

1. A sensitive system for detecting at least one of chemical and physical states or state changes within substance or mixtures of substances, characterized in that
a sensitive membrane or layer is disposed on or in an element replaceably connectable to a cannula, the element with cannula being introducible into a medium under measurement and forming an optical connection to an optical sensor system.

2. The system according to claim 1 characterized in that the optical sensor system has at least one optical detector and a light source.

3. The system according to claim 1, characterized in that the cannula is hollow throughout inside and forms an optical waveguide or at least one optical waveguide is guided through.

4. The system according to claim 1, characterized in that state changes within a package are detectable with the membrane or layer by interferometry, using surface plasmon resonance, spectroscopic methods or luminescence intensity change.

5. The system according to claim 1 characterized in that chemical concentrations, in particular at least one of hydrocarbon concentrations, hydrogen concentrations, oxygen concentrations, water content and physical parameters, in particular pressure or temperature, are detectable by layer thickness changes, luminescence changes, changes of refractive index or changes of absorption, transmission, reflectivity or the change of color of the layer or membrane.

6. The system according to claim 1, characterized in that one or more dyes or selective markers are contained in the membrane or layer.

7. The system according to claim 6, characterized in that the marker or dye is sensitive dependently on concentration or dependently on one of temperature and pressure.

8. The system according to claim 1, characterized in that the connectable element has a piercing protection and at least one openings.

9. The system according to claim 1, characterized in that the connectable element comprises at least one optical element.

10. The system according to claim 9, characterized in that the optical element is one of a fiber optic system, a GRIN lens, an optical rod, a disk or an optical lens.

11. The system according to claim 1, characterized in that the membrane or layer is formed directly in or on one of a fiber optic system and a fiber optical system.

12. The system according to claim 3 characterized in that membrane or layer is incorporated directly into the hollow cannula.

13. The system according to claim 1, characterized in that the membrane or layer is incorporated directly in the element wherein said element is hollow.

14. The system according to claim 1, characterized in that the membrane or layer is an optical contact with a fiber optic or optical system.

15. The system according to claim 1, characterized in that the membrane or layer is applied to a filler.

16. The system according to claim 1, characterized in that the membrane or layer is fixed on an adhesive film.

17. The system according to claim 1, characterized in that a calibration can be effected upon closing by a defined change of the measurand, including one of a vacuum and an excess pressure, a supply of gas and a temperature change.

18. The system according to claim 1, characterized in that at least one optical or chemical protective layer is applied to the membrane or layer.

19. The system according to claim 18, characterized in that at least one permeable metal and dielectric layer, lacquer layer, consisting of synthetic resin lacquer or acrylic lacquer, PTFE or PTFE-base protective layer is formed.

20. The system according to claim 1, characterized in that at least one of the membrane or layer and the element to be slipped on is at least one of disinfectable and sterilizable.

21. The system according to claim 1, characterized in that the element is adapted to be slipped or screwed onto the cannula for connection.

22. The system according to claim 21, characterized in that the connection involves a Luer lock connection.
